(19) United States
(12) Patent Application Publication
(10) Pub. No.: US 2014/0037320 A1
(43) Pub. Date: Feb. 6, 2014

(54) ROLLER HAVING MULTIPLE WRAPPED STRIPS

(71) Applicant: JENNY MARIE BERENS, LEXINGTON, KY (US)

(72) Inventor: JENNY MARIE BERENS, LEXINGTON, KY (US)

(21) Appl. No.: 13/565,900

(22) Filed: Aug. 3, 2012

(51) Int. Cl. G03G 15/02; G03G 21/00; G03G 15/08

(52) U.S. Cl. 399/100; 399/357; 399/281

(57) ABSTRACT

A roller according to one example embodiment includes a rotatable shaft and a plurality of strips wrapped around the shaft in an alternating relationship. The strips differ from each other in at least one of material, height and width. In one embodiment, the strips are spirally wrapped around the shaft. Each strip may be formed, for example, from a foam material, a felt material or a brush material.

### CROSS REFERENCES TO RELATED APPLICATIONS

None.

### BACKGROUND

1. Field of the Disclosure

The present invention relates generally to wrapped rollers and more particularly to a roller having multiple wrapped strips around its shaft.

2. Description of the Related Art

Electrophotographic image forming devices commonly use rotating rollers to perform various functions during a print operation. For example, rollers may be used to transport items such as toner particles or media sheets, to charge objects such as toner particles or other rollers or to clean surfaces or objects. The rollers typically include an outer working surface made from a material having properties selected to perform a precise function. The outer surfaces are formed from a variety of constructions including coated on the roller's shaft, formed integrally with the shaft, sleeve fit on the shaft, spirally wrapped around the shaft and flocked to the shaft. As image forming devices and toners become more complex, improved rollers are desired.

### SUMMARY

A roller according to one example embodiment includes a rotatable shaft and a plurality of strips wrapped around the shaft in an alternating relationship. The strips differ from each other in at least one of material, height and width. In one embodiment, the strips are spirally wrapped around the shaft. Each strip may be formed, for example, from a foam material, a felt material or a brush material.

A replaceable unit for an image forming device according to one example embodiment includes a housing having a reservoir for holding a quantity of toner. The replaceable unit also includes a roller having a shaft rotatably mounted to the housing and a plurality of strips wrapped around the shaft in an alternating relationship. The strips differ from each other in at least one of material, height and width.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a schematic view of an electrophotographic image forming device according to one example embodiment.

FIG. 2 is an exploded view of a roller wrapped with multiple strips of different materials according to one example embodiment.

FIG. 3 is a perspective view of the roller shown in FIG. 2.

FIG. 4 is a perspective view of a roller wrapped with a strip of a first foam material and a strip of a second foam material according to one example embodiment.

FIG. 5 is a perspective view of a roller wrapped with a strip of a foam material and a strip of a brush material according to one example embodiment.

FIG. 6 is a perspective view of a roller wrapped with multiple strips having different heights according to one example embodiment.

### DETAILED DESCRIPTION

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

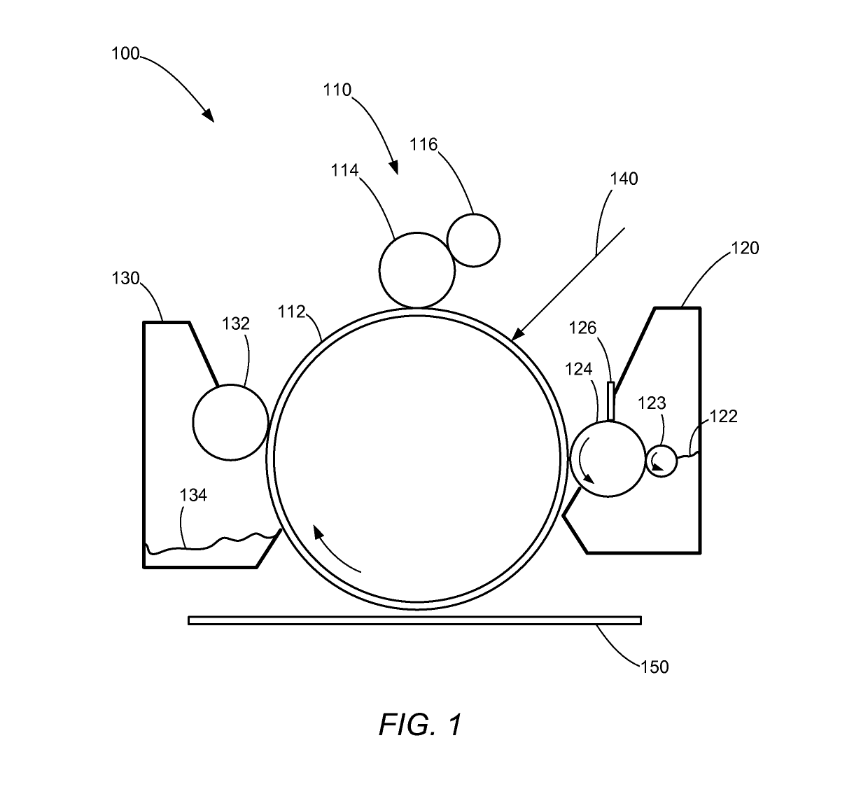

Referring now to the drawings and particularly to FIG. 1, an electrophotographic image forming device 100 is shown schematically according to one example embodiment. The electrophotographic printing process is well known in the art and, therefore, is described briefly herein. During a print operation, a charge roller 114 charges the surface of a photoconductive drum 112 to a predetermined voltage. In one embodiment, charge roller 114 rotates due to the frictional force between it and photoconductive drum 112. Alternatively, charge roller 114 may be driven by a gear system or the like as desired. The charged surface of photoconductive drum 112 is then selectively exposed to a laser light source 140 to selectively discharge the surface of photoconductive drum 112 and form an electrostatic latent image on photoconductive drum 112 corresponding to the image being printed. Charged toner from a developer unit 120 is picked up by the latent image on photoconductive drum 112 creating a toned image.

Developer unit 120 includes a toner sump 122 having toner particles stored therein. A toner adder roller 123 and a developer roller 124 are mounted in toner sump 122. Toner adder roller 123 moves toner stored in toner sump 122 to developer roller 124. Developer roller 124 is electrically charged and electrostatically attracts the toner particles supplied by toner adder roller 123. In one embodiment, toner adder roller 123 and developer roller 124 rotate in the same rotational direction such that their adjacent surfaces move in opposite directions to charge the toner transferred from the toner adder roller 123 to developer roller 124. This relationship also allows toner adder roller 123 to scrub any residual toner from the surface of developer roller 124. A doctor blade 126 disposed along developer roller 124 provides a substantially uniform layer of toner on developer roller 124. As developer roller 124 and photoconductive drum 112 rotate, toner particles are electrostatically transferred from developer roller 124 to the latent image on photoconductive drum 112 forming a toned image on the surface of photoconductive drum 112. In one embodiment, developer roller 124 and photoconductive drum 112 rotate in opposite rotational directions such that their adjacent surfaces move in the same direction to facilitate the transfer of toner from developer roller 124 to photoconductive drum 112.

The toned image is then transferred from photoconductive drum 112 to print media 150 (e.g., paper) either directly by photoconductive drum 112 or indirectly by an intermediate transfer member. A fusing unit (not shown) fuses the toner to print media 150. A cleaning roller 132 (or cleaning blade) of a cleaner unit 130 removes any residual toner adhering to photoconductive drum 112 after the toner is transferred to print media 150. In one embodiment, cleaning roller 132 rotates due to the frictional force between it and photoconductive drum 112. In other embodiments, cleaning roller 132 is driven by a gear system or the like either in the opposite rotational direction from photoconductive drum 112 such that their adjacent surfaces travel in the same direction or in the same rotational direction as photoconductive drum 112 such that their adjacent surfaces travel in opposite directions. Waste toner removed by cleaning roller 132 is held in a waste toner sump 134 in cleaner unit 130. The cleaned surface of photoconductive drum 112 is then ready to be charged again and exposed to laser light source 140 to continue the printing cycle.

Any toner particles remaining on the surface of photoconductive drum 112 after it passes cleaning roller 132 may adhere to the surface of charge roller 114 when charge roller 114 contacts photoconductive drum 112. Accordingly, a cleaning roller 116 is provided in contact with charge roller 114 to remove any remnant toner particles from the surface of charge roller 114. Cleaning roller 116, charge roller 114 and photoconductive drum 112 together form a photoconductor unit 110. In one embodiment, cleaning roller 116 rotates due to the frictional force between it and charge roller 114. In this embodiment, the diameters of cleaning roller 116 and charge roller 114 are selected to ensure adequate cleaning by cleaning roller 116 from a geometric standpoint, i.e., the working diameters of charge roller 114 and cleaning roller 116 differ from each other. In other embodiments, cleaning roller 116 is driven by a gear system or the like either in the opposite rotational direction from charge roller 114 such that their adjacent surfaces travel in the same direction or in the same rotational direction as charge roller 114 such that their adjacent surfaces travel in opposite directions. In these embodiments, the rotational speed of cleaning roller 116 relative to charge roller 114 may be selected to achieve a desired scrub ratio to improve its cleaning ability.

The components of image forming device 100 are replaceable as desired. For example, in one embodiment, photoconductor unit 110, developer unit 120 and cleaner unit 130 are housed in a replaceable unit with the main toner supply of image forming device 100. In another embodiment, photoconductor unit 110, developer unit 120 and cleaner unit 130 are provided in a first replaceable unit while the main toner supply of image forming device 100 is housed in a second replaceable unit. In another embodiment, developer unit 120 is provided with the main toner supply of image forming device 100 in a first replaceable unit and photoconductor unit 110 and cleaner unit 130 are provided in a second replaceable unit. It will be appreciated that any other combination of replaceable units may be used as desired. Further, in the case of an image forming device configured to print in color, separate replaceable units may be used for each toner color needed. For example, in one embodiment, the image forming device includes four photoconductor units 110, developer units 120 and cleaner units 130, each corresponding to a particular toner color (e.g., black, cyan, yellow and magenta) and each replaceable as discussed above.

As discussed above, some toner particles may remain on the surface of photoconductive drum 112 after it passes cleaning roller 132. These particles may be carried away on charge roller 114 forming a coating on the outer surface of charge roller 114. Such a coating may reduce the roughness and electrical resistivity of the outer surface of charge roller 114. This may lead to a reduction in the charging ability of charge roller 114 which may cause defects in the image developed on photoconductive drum 112. Accordingly, cleaning roller 116 is provided to clean these contaminants from the surface of charge roller 114. Typical toner particles are composed of one or more polymer binders (e.g., polyester, polystyrene, or a styrene-acrylic copolymer), a release agent (e.g., wax) and a colorant (e.g., a dye or pigment). More complex toners may include additives such as a surfactant, a dispersant, a charge control agent, an emulsifier, a UV absorber, a fluorescent additive and/or a plasticizer. In some instances, these additives may separate from the toner particle and attach to the charge roller 114 as a separate contaminant. Further, in some embodiments, photoconductive drum 112 may include a lubricant (e.g., zinc stearate) on its outer surface to reduce the torque on photoconductive drum 112. The lubricant may wear off the surface of photoconductive drum 112 over time creating another potential contaminant that may adhere to the surface of charge roller 114.

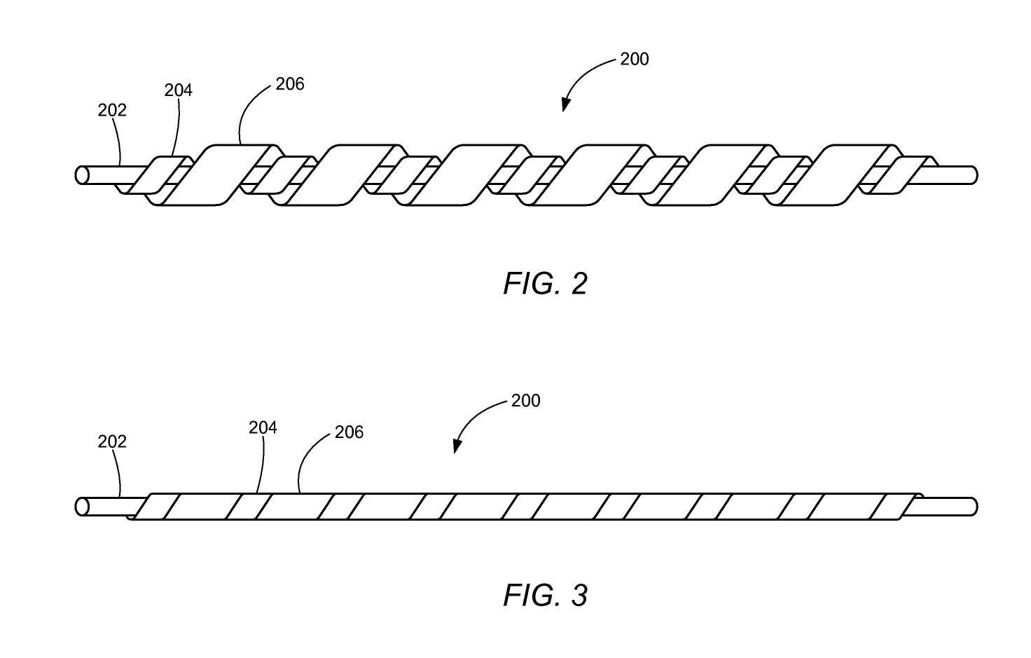

FIGS. 2 and 3 show a multi-wrapped roller 200 according to one example embodiment. Roller 200 includes a rotatable shaft 202 that may be formed of electrically conductive material (e.g., aluminum) or non-conductive material (e.g., non-conductive plastic). In the example embodiment illustrated, a pair of strips 204, 206 are spirally wrapped around shaft 202 in an alternating relationship. Strips 204, 206 are attached to shaft 202 such as by an adhesive. While two strips 204, 206 are shown, three or more strips may be wrapped around shaft 202 as desired. There is no theoretical upper limit on the number of strips; however, the number of strips is limited in practice by such factors as the width of each strip, the wrap angle, and the diameter and length of shaft 202.

In one embodiment, roller 200 is used as a cleaning roller, such as the cleaning roller 116 or cleaning roller 132 in image forming device 100. For example, the strips (e.g., 204, 206) of roller 200 may be selected to provide improved cleaning of charge roller 114. The removal of contaminants from charge roller 114 requires several steps. First, the contaminant must be loosened from the surface of charge roller 114. Various methods, including, for example, the use of mechanical force and/or electrostatic force, may be used to loosen the contaminant depending on the nature of the adhesion force between the contaminant and charge roller 114. Second, the contaminant must be removed from the surface of charge roller 114. Methods such as mechanical force and/or electrostatic force may also be used to remove the contaminant. Third, the contaminant must be retained by cleaning roller 116 to ensure that it does not return to the surface of charge roller 114.

The material of each strip (e.g., 204, 206) of roller 200 may be selected to address a particular type of contaminant or a particular type of contaminant adhesion. As discussed above, multiple potential contaminants may be present in image forming device 100, such as, for example, residual toner particles (with or without additives), additives separated from toner particles and lubricants. The contaminants may differ from each other in one or more of charge, size and shape and may adhere differently to charge roller 114. The material of each strip (e.g., 204, 206) may be selected to clean a particular type of contaminant thereby improving the overall cleaning ability of cleaning roller 116 in comparison with a traditional cleaning roller possessing a single surface type. Further, the material of each strip (e.g., 204, 206) of roller 200 may also be selected to perform a specific cleaning function so that all of the strips of roller 200 in combination perform a complete cleaning. For example, in one embodiment, one strip is formed from a material selected to mechanically scrub the surface of charge roller 114 to remove the adhered contaminants. A second strip and a third strip are selected from materials that attract and trap particles that are positively and negatively charged, respectively.

The strips (e.g., 204, 206) of roller 200 may be formed from a variety of different materials useful for cleaning the surface of charge roller 114. Example materials include, but are not limited to, foams, felts and brush fibers/filaments. Foams, such as polymer foams, may be selected from a wide range of chemistry, morphology, density, hardness, etc. Depending on the contaminant or adhesion mechanism that the foam has been selected to target, the pores of the foam may be open or closed. The surface to volume fraction of the foam may also be optimized as desired. Brush weaves of various filament population densities, such as brushes made with polymer filaments, may be selected from a wide range of filament chemistry, length, diameter, denier, etc. The surface of each strip may be low-friction or highly abrasive as desired. Each strip may also be electrically conductive or non-conductive as desired. The material of each strip may be further selected based on its tribo-electrical charge properties as desired.

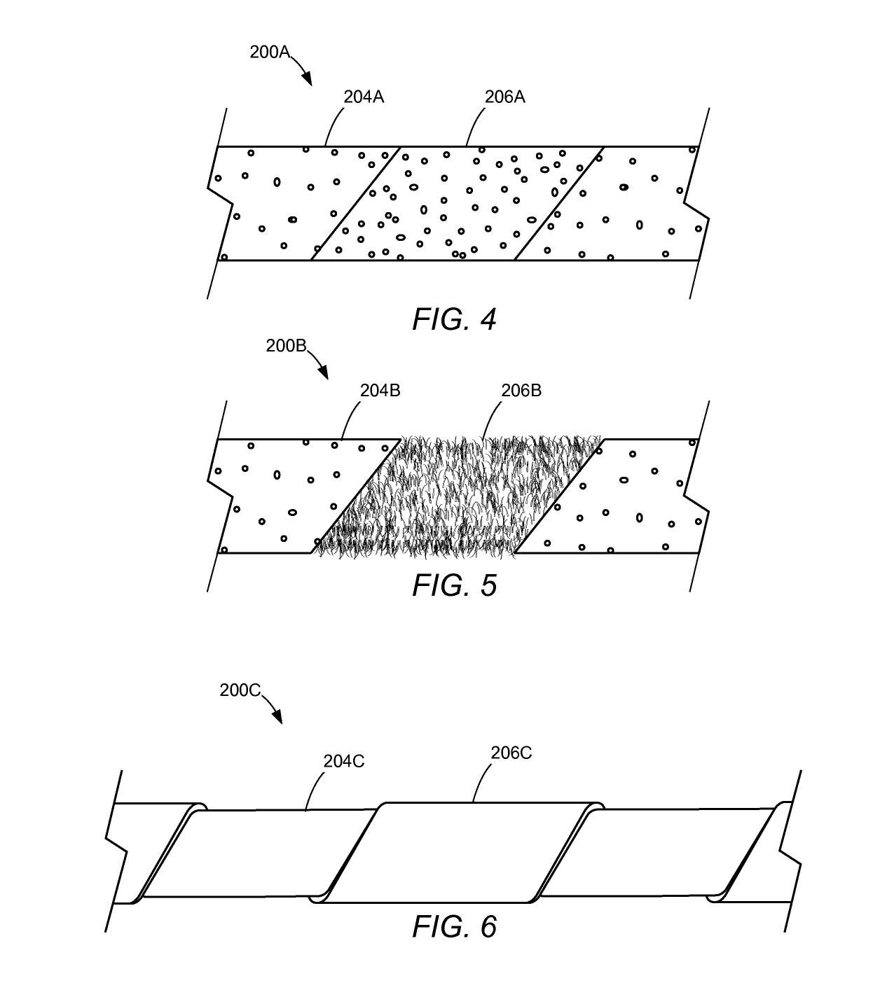

Each strip (e.g., 204, 206) of roller 200 may be composed of a different material. For example, FIG. 4 shows an embodiment where strip 204A of roller 200A is a first type of foam and strip 206A is a second type of foam. FIG. 5 shows an example embodiment where strip 204B of roller 200B is a foam material and strip 206B is a brush material. It will be appreciated that many different material combinations are envisioned based on the desired application of roller 200 such as a roller having strips of different foam, felt and/or brush materials (e.g., a roller having strips of a first brush material and a second brush material, a roller having strips of a felt material and a brush material and so on). Further, each strip (e.g., 204, 206) of roller 200 may have different surface treatments applied to each strip in order to alter the cleaning properties of the base material to tailor roller 200 for a specific application. For example, in the embodiment shown in FIGS. 2 and 3, each strip 204, 206 may have a different surface treatment or one strip 204 or 206 may include a surface treatment and the other strip 204 or 206 may not.

Where cleaning roller 116 rotates as a result of the frictional force between it and charge roller 114, one strip (e.g., 204 or 206) of roller 200 may be selected as the “driving strip” to contact and receive rotational force from charge roller 114. The material of the driving strip may be selected based on the desired friction force in the nip formed between charge roller 114 and cleaning roller 116. The additional strip(s) of roller 200 may be selected to perform the desired cleaning function.

The strips (e.g., 204, 206) of roller 200 may have different widths and/or heights from each other or the same width and/or height. In the example embodiment shown in FIGS. 2 and 3, strip 204 is narrower than strip 206 and strips 204, 206 have substantially the same height. In an alternative embodiment shown in FIG. 6, strips 204C and 206C of roller 200C have substantially the same width and strip 206C has a greater height than strip 204C. It will be appreciated that any combination of heights and widths may be used as desired. For example, the strips of roller 200 may differ in height in order to compensate for their different material properties, such as various material hardness and compression sets. The height of each strip may be selected to improve its cleaning capacity by controlling the force and/or width of the nip formed between cleaning roller 116 and charge roller 114. The height of a driving strip may also be selected to control the driving force of the strip when cleaning roller 116 rotates as a result of the frictional force between it and charge roller 114 as discussed above.

In another embodiment, roller 200 is used as a toner adder roller, such as the toner adder roller 123 in image forming device 100. The strips (e.g., 204, 206) of roller 200 may be selected to provide improved performance of toner adder roller 123. In this embodiment, the material of each strip (e.g., 204, 206) of roller 200 may be selected to perform a particular function of toner adder roller 123. For example, in one embodiment, a first strip is formed from a material selected to apply toner mechanically and/or electrostatically to developer roller 124, a second strip is formed from a material selected to charge the toner supplied by toner adder roller 123 to developer roller 124 and a third strip is formed from a material selected to remove residual toner from developer roller 124 mechanically and/or electrostatically. As discussed above, the strips (e.g., 204, 206) of roller 200 may be formed from a variety of materials and may have various dimensions.

Of course, it will also be appreciated that a roller having multiple wrapped strips, such as roller 200, may also be useful in applications outside of the imaging field where strips formed from different materials and/or having different dimensions are beneficial. For example, a roller for cleaning or polishing may include a first strip formed from a material selected to mechanically scrub dirt from a surface and a second strip formed from a material selected to retain dust and dirt from the surface such as by electrostatically attracting the dust and dirt.

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A roller, comprising:
a rotatable shaft; and
a plurality of strips wrapped around the shaft in an alternating relationship, the strips differing from each other in at least one of material, height and width.

2. The roller of claim 1, wherein the strips are composed of different materials.

3. The roller of claim 2, wherein a first of the strips is composed of a first foam material and a second of the strips is composed of a second foam material different from the first foam material.

4. The roller of claim 3, wherein the first foam material differs from the second foam material in at least one of pore type, pore density and hardness.

5. The roller of claim 2, wherein a first of the strips is composed of a foam material and a second of the strips is composed of a brush material.

6. The roller of claim 1, wherein each of the strips is composed of at least one of a foam material, a felt material and a brush material.

7. The roller of claim 1, wherein the strips have different heights.

8. The roller of claim 1, wherein the strips have different widths.

9. The roller of claim 1, wherein each of the strips is spirally wrapped around the shaft.

10. A replaceable unit for an image forming device, comprising:
a housing having a reservoir for holding a quantity of toner; and
a roller having a shaft rotatably mounted to the housing and a plurality of strips wrapped around the shaft in an alternating relationship, the strips differing from each other in at least one of material, height and width.

11. The replaceable unit of claim 10, further comprising a developer roller rotatably mounted to the housing and positioned to supply toner to a photoconductive drum, the roller forming a toner adder roller positioned to supply toner from the reservoir to the developer roller.

12. The replaceable unit of claim 10, further comprising a second roller rotatably mounted to the housing, the first roller forming a cleaning roller having an outer surface in contact with an outer surface of the second roller for cleaning the outer surface of the second roller.

13. The replaceable unit of claim 12, wherein the second roller is a charge roller positioned to charge a photoconductive drum.

14. The replaceable unit of claim 12, wherein the second roller is a photoconductive drum.

15. The replaceable unit of claim 10, wherein the strips of the roller are composed of different materials.

16. The replaceable unit of claim 15, wherein a first of the strips of the roller is composed of a first foam material and a second of the strips of the roller is composed of a second foam material different from the first foam material.

17. The replaceable unit of claim 16, wherein the first foam material differs from the second foam material in at least one of pore type, pore density and hardness.

18. The replaceable unit of claim 15, wherein a first of the strips of the roller is composed of a foam material and a second of the strips of the roller is composed of a brush material.

19. The replaceable unit of claim 10, wherein the strips of the roller have different heights.

20. The replaceable unit of claim 10, wherein the strips of the roller have different widths.
